(19) United States
(12) Patent Application Publication
(10) Pub. No.: US 2024/0381302 A1
(43) Pub. Date: Nov. 14, 2024

(54) METHOD AND USER EQUIPMENT TO DEFINE MOBILITY MANAGEMENT STATE TRANSITION DUE TO SATELLITE DISCONTINUOUS COVERAGE

(71) Applicant: MediaTek Singapore Pte. Ltd., Singapore (SG)

(72) Inventors: Puneet (Last Name not provided), Bengaluru KA (IN); Marko Niemi, Oulu, FL (US)

(21) Appl. No.: 18/646,861

(22) Filed: Apr. 26, 2024

(30) Foreign Application Priority Data
May 8, 2023 (IN) 202321032539
May 16, 2023 (IN) 202321034389
Aug. 25, 2023 (IN) 202321057201

(51) Int. Cl. H04W 64/00; H04W 60/04; H04W 60/06

(52) U.S. Cl. CPC H04W 64/006; H04W 60/04; H04W 60/06

(57) ABSTRACT

A method and a user equipment (UE) to define mobility management state transition due to satellite discontinuous coverage are provided. The method includes: determining whether an access stratum (AS) is deactivated due to a discontinuous coverage or during the discontinuous coverage in a mobility management; and entering a specific state, when the access stratum (AS) is deactivated due to the discontinuous coverage or during the discontinuous coverage in the mobility management.

This application claims the benefit of India Provisional application Serial No. 202321032539, filed May 8, 2023, and India Provisional application Serial No. 202321034389, filed May 16, 2023, and India Provisional application Serial No. 202321057201, filed Aug. 25, 2023, the disclosure of which is incorporated by reference herein in its entirety.

### TECHNICAL FIELD

The disclosure relates in general to a method and an electronic device, and more particularly to a method and a user equipment (UE) to define mobility management state transition due to satellite discontinuous coverage.

### BACKGROUND

Deployment option for satellite E-UTRAN access, in which shorter periods of satellite E-UTRAN access radio coverage are followed by longer periods of satellite E-UTRAN access coverage gaps. During the coverage gaps, the access stratum may be deactivated. These coverage gaps are called discontinuous coverage.

The EMM state is not defined when the access stratum (AS) is deactivated due to discontinuous coverage or during discontinuous coverage. If a user equipment (UE) doesn't enter to a proper state during discontinuous coverage, then user equipment (UE) could initiate a MO signaling or MO data based on current EMM state which can activate access stratum (AS) and leads to power consumption in case of discontinuous coverage.

Furthermore, 5GMM state is not defined when the access stratum (AS) is deactivated due to discontinuous coverage or during discontinuous coverage. If a user equipment (UE) doesn't enter to a proper state during discontinuous coverage, then the user equipment (UE) could initiate a MO signaling or MO data based on current 5GMM state which can activate the access stratum (AS) and leads to power consumption in case of discontinuous coverage.

### SUMMARY

The disclosure is directed to a method and a user equipment (UE) to define mobility management state transition due to satellite discontinuous coverage.

According to one embodiment, a method for a user equipment (UE) is provided. The method includes: determining whether an access stratum (AS) is deactivated due to a discontinuous coverage or during the discontinuous coverage in a mobility management; and entering a specific state, when the access stratum (AS) is deactivated due to the discontinuous coverage or during the discontinuous coverage in the mobility management. The specific state is either an xMM-DEREGISTERED.NO-CELL-AVAILABLE state entered by the user equipment (UE), when either the access stratum (AS) is deactivated due to the discontinuous coverage or the user equipment (UE) is in the discontinuous coverage and the user equipment (UE) in deregistered is state; or an xMM-REGISTERED.NO-CELL-AVAILABLE state entered by the user equipment (UE), when either the access stratum (AS) is deactivated due to the discontinuous coverage or the user equipment (UE) is in the discontinuous coverage and the user equipment (UE) is in the registered state.

According to another embodiment, a user equipment (UE) is provided. The user equipment (UE) includes a transceiver and a processor. The transceiver is configured to wirelessly communicate with a network. The processor is coupled to the transceiver and configured to perform operations comprising: determining whether an access stratum (AS) is deactivated due to a discontinuous coverage or during the discontinuous coverage in a mobility management; and entering a specific state, when the access stratum (AS) is deactivated due to the discontinuous coverage or during the discontinuous coverage in the mobility management. The specific state is either an xMM-DEREGISTERED.NO-CELL-AVAILABLE state entered by the user equipment (UE), when either the access stratum (AS) is deactivated due to the discontinuous coverage or the user equipment (UE) is in the discontinuous coverage and the user equipment (UE) is in deregistered state; or an xMM-REGISTERED.NO-CELL-AVAILABLE state entered by the user equipment (UE), when either the access stratum (AS) is deactivated due to the discontinuous coverage or the user equipment (UE) is in the discontinuous coverage and the user equipment (UE) is in the registered state.

### BRIEF DESCRIPTION OF THE DRAWINGS

FIG. 1 shows a schematic diagram of a structure of a mobile communication system according to an embodiment of the present disclosure.

FIG. 2 illustrates a method to define a specific MM state transition due to the satellite discontinuous coverage according to one embodiment of the present disclosure.

FIG. 3 illustrates the user equipment (UE) in accordance with an implementation of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

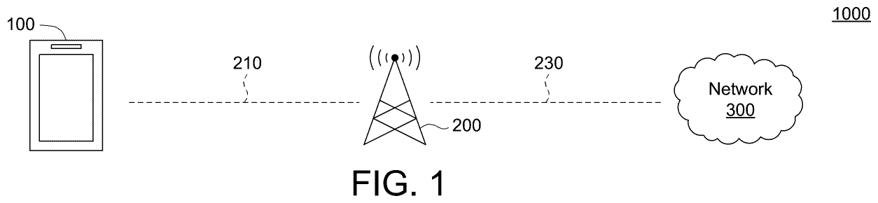

Please refer to FIG. 1, which shows a schematic diagram of a structure of a mobile communication system 1000 according to an embodiment of the present disclosure. The mobile communication system 1000 may be a long term evolution (Long Term Evolution, LTE) system, a fifth-generation mobile communication technology 5G new radio (new radio, NR) system, a machine to machine (Machine To Machine, M2M) system, or a future evolved sixth-generation communication system. The mobile communication system 1000 includes a user equipment (UE) 100, a base station 200, a terminal 240 and a core network device 260. The base station 200 and the core network device 300 may be collectively referred to as a network device.

The base station 200 may be configured to perform mutual conversion between a received radio frame and an IP packet, and may further coordinate attribute management on an air interface. For example, the base station 200 may be an evolved NodeB (evolved NodeB, eNB) in LTE, or a base station that has a centralized distributed architecture and that is used in a 5G system. The base station 200 may also be an access point (Access Point, AP), a transmission node (Trans Point, TRP), a central unit (Central Unit, CU), or another network entity, and may include some or all of functions of the foregoing network entities. In addition, the base station 200 further includes a relay station. The relay station is a transmission station that receives data and/or other information from an upstream station and sends data and/or other information to a downstream station. The relay station may also be a terminal that provides relay transmission for another terminal. The relay station may also be referred to as a repeater.

The mobile communication system 1000 may be a heterogeneous system including different types of base stations (for example, a macro base station, a picocell base station, a femto base station, and a repeater). These different types of base stations may have different transmit power levels, different coverage areas, and different interference impact. For example, the macro base station may have a high transmit power level (for example, 20 watts), and the picocell station, the femto base station, and the repeater may have a low transmit power level (for example, 1 watt).

The base station 200 and the user equipment 100 establish a radio connection through a radio air interface. The radio air interface may be a radio air interface based on an LTE standard, or the radio air interface is a radio air interface based on a 5G standard. For example, the radio air interface is NR, or the radio air interface may be a radio air interface based on a 5G-based technology standard of a more next-generation mobile communication network.

The user equipment 100 may be a device that provides voice and/or data communication for a user. The user equipment 100 may communicate with one or more core network devices 300 through a radio access network (Radio Access Network, RAN) provided by the base station 200. The user equipment 100 may be a mobile terminal, for example, a mobile phone or a computer that has a mobile terminal, for example, a portable, pocket-sized, handheld, computer built-in, or vehicle-mounted mobile apparatus.

Specifically, the base station 200 may be configured to communicate with the user equipment 200 through a wireless interface 210 under control of a network device controller (not shown in the FIG. 1). In some embodiments, the network device controller may be a part of the core network device 300, or may be integrated into the base station 200. The base station 200 may transmit information or user data to the core network device 300 through an interface 230 (for example, an S1 interface). The base station 200 and the core network device 300 may also communicate with each other through an interface (for example, an X2 interface, which is not shown in the FIG. 1).

Currently, the EMM state or the 5GMM state is not defined when the access stratum (AS) is deactivated due to discontinuous coverage or during discontinuous coverage. If a user equipment (UE) doesn't enter to a proper state during discontinuous coverage, then user equipment (UE) could initiate a MO signaling or MO data based on current EMM state which can activate access stratum (AS) and leads to power consumption in case of discontinuous coverage.

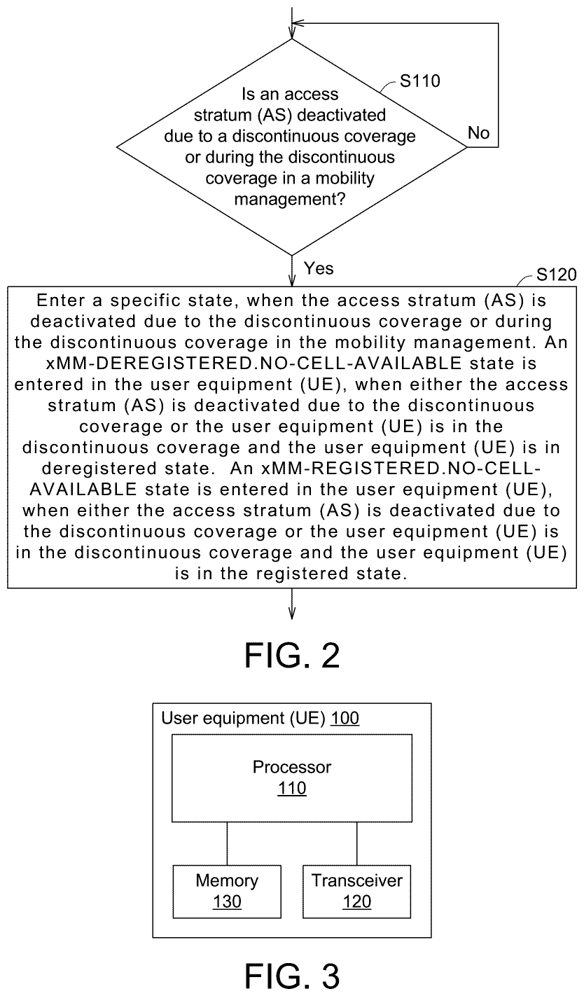

To solve the current problem, a specific MM state for the user equipment (UE) is provided. Please refer to FIG. 2, which illustrates a method to define a specific MM state transition due to the satellite discontinuous coverage according to one embodiment of the present disclosure. The method includes steps S110 to S120.

In the step S110, whether an access stratum (AS) is deactivated due to a discontinuous coverage or during the discontinuous coverage in a mobility management is determined. If the access stratum (AS) is deactivated due to the discontinuous coverage or during the discontinuous coverage in the mobility management, then the process proceeds to the step S120.

In the step S120, the user equipment (UE) shall enter a specific state, when the access stratum (AS) is deactivated due to the discontinuous coverage or during the discontinuous coverage in the mobility management. An xMM-DEREGISTERED.NO-CELL-AVAILABLE state is entered in the user equipment (UE), when either the access stratum (AS) is deactivated due to the discontinuous coverage or the user equipment (UE) is in the discontinuous coverage and the user equipment (UE) in is deregistered state. An xMM-REGISTERED.NO-CELL-AVAILABLE state is entered in the user equipment (UE), when either the access stratum (AS) is deactivated due to the discontinuous coverage or the user equipment (UE) is in the discontinuous coverage and the user equipment (UE) is in the registered state.

In a first embodiment, the mobility management is EPS mobility management (EMM). The user equipment (UE) shall enter to a specific EMM state when the access stratum (AS) is deactivated due to the discontinuous coverage or during the discontinuous coverage.

The state is chosen in the user equipment (UE) when the access stratum (AS) is deactivated due to the discontinuous coverage or during the discontinuous coverage.

When the access stratum (AS) is deactivated due to the discontinuous coverage or during the discontinuous coverage, then the user equipment (UE) could choose EMM state as:
EMM-DEREGISTERED.NO-CELL-AVAILABLE, if the access stratum (AS) is deactivated due to discontinuous coverage or during discontinuous coverage in UE deregistered state;
EMM-REGISTERED.NO-CELL-AVAILABLE, if the access stratum (AS) is deactivated due to discontinuous coverage or during discontinuous coverage in UE registered state.

In the state entered at/after the access stratum (AS) deactivation due to the discontinuous coverage or during the discontinuous coverage, the user equipment (UE) shall not initiate any EMM procedure except for cell and PLMN reselection and/or activation of the access stratum (AS).

The user equipment (UE) can activate the access stratum (AS) by initiating EMM attach procedure or EMM tracking area update procedure.

Moreover, in a second embodiment, the mobility management is EPS mobility management (EMM). The user equipment (UE) shall enter to a specific EMM state when the access stratum (AS) is deactivated due to discontinuous coverage or during discontinuous coverage.

The state is chosen in the user equipment (UE) when the access stratum (AS) is deactivated due to the discontinuous coverage or during the discontinuous coverage.

When the access stratum (AS) is deactivated due to the discontinuous coverage or during the discontinuous coverage, then the user equipment (UE) could choose the EMM state as:
EMM-DEREGISTERED.DISCONTINUOUS-COVERAGE, if the access stratum (AS) is deactivated due to discontinuous coverage or during discontinuous coverage in deregistered state; and
EMM-REGISTERED.DISCONTINUOUS-COVERAGE, if the access stratum (AS) is deactivated due to discontinuous coverage or during discontinuous coverage in registered state.

In the state entered at/after the access stratum (AS) deactivation due to the discontinuous coverage or during the discontinuous coverage, the user equipment (UE) shall not initiate any EMM procedure except for cell and PLMN reselection and/or activation of the access stratum (AS).

The user equipment (UE) could activate the access stratum (AS) by initiating the EMM attach procedure or the EMM tracking area update procedure.

Further, in a third embodiment, the mobility management is EPS mobility management (EMM). The user equipment (UE) shall enter to a specific EMM state when
the user equipment (UE) activates unavailability period; and/or
the unavailability period is activated for discontinuous coverage; and/or
the unavailability period is activated for other reasons (see 3GPP TS 24.501 subclause 5.3.26); and/or
the access stratum (AS) is deactivated for 3GPP access and/or
the unavailability period is activated; and/or
the access stratum (AS) is deactivated for the discontinuous coverage; and/or
the access stratum (AS) is deactivated other reasons (see 3GPP TS 24.501 subclause 5.3.26).

The state is chosen in the user equipment (UE) when
the user equipment (UE) activates the unavailability period; and/or
the unavailability period is activated for the discontinuous coverage; and/or
the unavailability period is activated for other reasons (see 3GPP TS 24.501 subclause 5.3.26); and/or
the access stratum (AS) is deactivated for 3GPP access; and/or
the unavailability period is activated; and/or
the access stratum (AS) is deactivated for discontinuous coverage; and/or
the access stratum (AS) is deactivated other reasons (see 3GPP TS 24.501 subclause 5.3.26);
   when
the user equipment (UE) activates the unavailability period; and/or
the unavailability period is activated for discontinuous coverage; and/or
the unavailability period is activated for other reasons (see 3GPP TS 24.501 subclause 5.3.26); and/or
the access stratum (AS) is deactivated for 3GPP access; and/or
the unavailability period is activated; and/or
the access stratum (AS) is deactivated for discontinuous coverage; and/or
the access stratum (AS) is deactivated other reasons (see 3GPP TS 24.501 subclause 5.3.26); and/or
,then user equipment (UE) can choose EMM state as:
EMM-DEREGISTERED.NO-CELL-AVAILABLE, in deregistered state; and/or
EMM-REGISTERED.NO-CELL-AVAILABLE, in registered state.

In the state entered at/after
the user equipment (UE) activates the unavailability period; and/or
the unavailability period is activated for the discontinuous coverage; and/or
the unavailability period is activated for other reasons (see 3GPP TS 24.501 subclause 5.3.26); and/or
the access stratum (AS) is deactivated for 3GPP access; and/or
the unavailability period is activated; and/or
the access stratum (AS) is deactivated for the discontinuous coverage; and/or
the access stratum (AS) is deactivated other reasons (see 3GPP TS 24.501 subclause 5.3.26);
then, the user equipment (UE) shall not initiate any EMM procedure except for cell and PLMN reselection and/or activation of the access stratum (AS).

The user equipment (UE) could activate the access stratum (AS) by initiating EMM attach procedure or EMM tracking area update procedure.

Similar to the solutions disclosed in the first embodiment to the third embodiment, the 5GMM also needs to be defined the 5GMM state when access stratum (AS) is deactivated due to the discontinuous coverage or during the discontinuous coverage.

In the fourth embodiment, the mobility management is 5G mobility management (5GMM). The user equipment (UE) shall enter to a specific 5GMM state when the access stratum (AS) is deactivated due to the discontinuous coverage or during the discontinuous coverage.

The state is chosen in the user equipment (UE) when the access stratum (AS) is deactivated due to discontinuous coverage or during discontinuous coverage.

When the access stratum (AS) is deactivated due to the discontinuous coverage or during the discontinuous coverage, then the user equipment (UE) could choose the 5GMM state as
5GMM-DEREGISTERED.NO-CELL-AVAILABLE, if the access stratum (AS) is deactivated due to the discontinuous coverage or during the discontinuous coverage in the deregistered state; and
5GMM-REGISTERED.NO-CELL-AVAILABLE, if the access stratum (AS) is deactivated due to the discontinuous coverage or during the discontinuous coverage in the registered state.

In the state entered at/after the access stratum (AS) deactivation due to the discontinuous coverage or during the discontinuous coverage, the user equipment (UE) shall not initiate any 5GMM procedure except for cell and PLMN reselection and/or activation of the access stratum (AS).

The user equipment (UE) could activate the access stratum (AS) by initiating the 5GMM attach procedure or the 5GMM tracking area update procedure.

In the fifth embodiment, the mobility management is 5G mobility management (5GMM). The user equipment (UE) shall enter to a specific 5GMM state when the access stratum (AS) is deactivated due to discontinuous coverage or during discontinuous coverage.

The state is chosen in the user equipment (UE) when the access stratum (AS) is deactivated due to the discontinuous coverage or during the discontinuous coverage.

When the access stratum (AS) is deactivated due to the discontinuous coverage or during the discontinuous coverage, then the user equipment (UE) could choose the 5GMM state as:
5GMM-DEREGISTERED.DISCONTINUOUS-COVERAGE, if the access stratum (AS) is deactivated due to the discontinuous coverage or during the discontinuous coverage in the deregistered state; and
5GMM-REGISTERED. DISCONTINUOUS-COVERAGE, if the access stratum (AS) is deactivated due to the discontinuous coverage or during the discontinuous coverage in the registered state.

In the state entered at/after the access stratum (AS) deactivation due to the discontinuous coverage or during the discontinuous coverage, the user equipment (UE) shall not initiate any 5GMM procedure except for cell and PLMN reselection and/or activation of the access stratum (AS).

The user equipment (UE) could activate the access stratum (AS) by initiating the initial registration or the mobility registration update procedure.

In the sixth embodiment, the mobility management is 5G mobility management (5GMM). The user equipment (UE) shall enter to a specific 5GMM state when
the user equipment (UE) activates the unavailability period; and/or
the unavailability period is activated for the discontinuous coverage; and/or
the unavailability period is activated for other reasons (see 3GPP TS 24.501 subclause 5.3.26); and/or
the access stratum (AS) is deactivated for 3GPP access; and/or
the unavailability period is activated; and/or
the access stratum (AS) is deactivated for discontinuous coverage; and/or
the access stratum (AS) is deactivated other reasons (see 3GPP TS 24.501 subclause 5.3.26).

The state is chosen in the user equipment (UE) when
the user equipment (UE) activates the unavailability period; and/or
the unavailability period is activated for the discontinuous coverage; and/or
the unavailability period is activated for other reasons (see 3GPP TS 24.501 subclause 5.3.26); and/or
the access stratum (AS) is deactivated for 3GPP access; and/or
the unavailability period is activated; and/or
the access stratum (AS) is deactivated for the discontinuous coverage; and/or
the access stratum (AS) is deactivated other reasons (see 3GPP TS 24.501 subclause 5.3.26);
   when
the user equipment (UE) activates the unavailability period; and/or
the unavailability period is activated for the discontinuous coverage; and/or
the unavailability period is activated for other reasons (see 3GPP TS 24.501 subclause 5.3.26); and/or
the access stratum (AS) is deactivated for the 3GPP access; and/or
the unavailability period is activated; and/or
the access stratum (AS) is deactivated for discontinuous coverage; and/or
the access stratum (AS) is deactivated other reasons (see 3GPP TS 24.501 subclause 5.3.26); and/or,
,then the user equipment (UE) could choose the 5GMM state as:
5GMM-DEREGISTERED.NO-CELL-AVAILABLE, in the deregistered state; and/or
5GMM-REGISTERED.NO-CELL-AVAILABLE, in the registered state.

In the state entered at/after
the user equipment (UE) activates the unavailability period; and/or
the unavailability period is activated for the discontinuous coverage; and/or
the unavailability period is activated for other reasons (see 3GPP TS 24.501 subclause 5.3.26); and/or
the access stratum (AS) is deactivated for the 3GPP access; and/or
the unavailability period is activated; and/or
the access stratum (AS) is deactivated for the discontinuous coverage; and/or
the access stratum (AS) is deactivated for other reasons (see 3GPP TS 24.501 subclause 5.3.26);
then, the user equipment (UE) shall not initiate any 5GMM procedure except for cell and PLMN reselection and/or activation of the access stratum (AS).

The user equipment (UE) could activate the access stratum (AS) by initiating the initial registration or the mobility registration update procedure.

Please refer to FIG. 3, which illustrates the user equipment (UE) 100 in accordance with an implementation of the present disclosure. The user equipment 100 may perform various functions to implement schemes, techniques, processes and methods described herein pertaining to user equipment (UE) behavior in mobile communications, including the various schemes described above with respect to various proposed designs, concepts, schemes, systems and methods described above, including the network environment 100, as well as processes described below.

The user equipment (UE) 100 may be a part of an electronic apparatus, which may be a network apparatus, such as a portable or mobile apparatus, a wearable apparatus, a vehicular device or a vehicle, a wireless communication apparatus or a computing apparatus. For instance, the user equipment (UE) 100 may be implemented in a smartphone, a smart watch, a personal digital assistant, an electronic control unit (ECU) in a vehicle, a digital camera, or a computing equipment such as a tablet computer, a laptop computer or a notebook computer. The user equipment may also be a part of a machine type apparatus, which may be an IoT apparatus such as an immobile or a stationary apparatus, a home apparatus, a roadside unit (RSU), a wire communication apparatus or a computing apparatus. For instance, the user equipment (UE) may be implemented in a smart thermostat, a smart fridge, a smart door lock, a wireless speaker or a home control center. When implemented in or as a network apparatus, the user equipment (UE) 100 may be implemented in an eNodeB in an LTE, LTE-Advanced or LTE-Advanced Pro network or in a gNB or TRP in a 5G network, an NR network or an IoT network.

In some implementations, the user equipment (UE) 100 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, the user equipment (UE) 100 may be implemented in or as a network apparatus. The user equipment (UE) 100 may include at least some of those components shown in the FIG. 3, such as a processor 110, a transceiver 120 and a memory 130, for example. The user equipment (UE) 100 may further include one or more other components not pertinent to the proposed scheme of the present disclosure (e.g., internal power supply, display device and/or user interface device).

In one aspect, the processor 110 may be implemented in the form of one or more single-core processors, one or more multi-core processors, or one or more CISC or RISC processors. That is, even though a singular term “a processor” is used herein to refer to the processor 110, the processor 110 may include multiple processors in some implementations and a single processor in other implementations in accordance with the present disclosure. In another aspect, the processor 110 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, the processor is a special-purpose machine specifically designed, arranged and configured to perform specific tasks including those pertaining to the user equipment (UE) 100 behavior for failed registration and service requests for emergency services fallback in mobile communications in accordance with various implementations of the present disclosure.

The transceiver 120 is coupled to the processor 110. The transceiver 120 may be capable of wirelessly transmitting and receiving data. In some implementations, the transceiver 120 may be capable of wirelessly communicating with different types of wireless networks of different radio access technologies (RATs). In some implementations, the transceiver 120 may be equipped with a plurality of antenna ports (not shown) such as, for example, four antenna ports. That is, the transceiver 120 may be equipped with multiple transmit antennas and multiple receive antennas for multiple-input multiple-output (MIMO) wireless communications.

The memory 130 is coupled to the processor 110 and stores data therein. The memory 130 may include a type of random-access memory (RAM) such as dynamic RAM (DRAM), static RAM (SRAM), thyristor RAM (T-RAM) and/or zero-capacitor RAM (Z-RAM). Alternatively, or additionally, the memory 113 may include a type of read-only memory (ROM) such as mask ROM, programmable ROM (PROM), erasable programmable ROM (EPROM) and/or electrically erasable programmable ROM (EEPROM). Alternatively, or additionally, the memory 130 may include a type of non-volatile random-access memory (NVRAM) such as flash memory, solid-state memory, ferroelectric RAM (FeRAM), magnetoresistive RAM (MRAM) and/or phase-change memory.

The processor 110 of the user equipment (UE) 100, is configured to perform operations described as above.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A method for a user equipment (UE), comprising:
determining whether an access stratum (AS) is deactivated due to a discontinuous coverage or during the discontinuous coverage in a mobility management; and
entering a specific state, when the access stratum (AS) is deactivated due to the discontinuous coverage or during the discontinuous coverage;
wherein
the specific state is either an xMM-DEREGISTERED.NO-CELL-AVAILABLE state entered by the user equipment (UE), when either the access stratum (AS) is deactivated due to the discontinuous coverage or the user equipment (UE) is in the discontinuous coverage and the user equipment (UE) is in deregistered state; or
an xMM-REGISTERED.NO-CELL-AVAILABLE state entered by the user equipment (UE), when either the access stratum (AS) is deactivated due to the discontinuous coverage or the user equipment (UE) is in the discontinuous coverage and the user equipment (UE) is in the registered state.

2. The method according to claim 1, wherein the mobility management is EPS mobility management (EMM), the xMM-DEREGISTERED.NO-CELL-AVAILABLE state is an EMM-DEREGISTERED.NO-CELL-AVAILABLE state, and the xMM-REGISTERED.NO-CELL-AVAILABLE state is an EMM-REGISTERED.NO-CELL-AVAILABLE state.

3. The method according to claim 1, wherein the mobility management is 5G mobility management (5GMM), the xMM-DEREGISTERED.NO-CELL-AVAILABLE state is a 5GMM-DEREGISTERED.NO-CELL-AVAILABLE state, and the xMM-REGISTERED.NO-CELL-AVAILABLE state is a 5GMM-REGISTERED.NO-CELL-AVAILABLE state.

4. The method according to claim 1, further comprising:
entering the specific state, when an unavailability period is activated due to discontinuous coverage.

5. The method according to claim 1, further comprising:
entering the specific state, when the user equipment (UE) activates an unavailability period.

6. The method according to claim 1, further comprising:
entering the specific state, when the access stratum (AS) is deactivated for a 3GPP access.

7. The method according to claim 1, wherein the user equipment (UE) initiates a mobility management procedure for cell and PLMN reselection.

8. The method according to claim 1, wherein the user equipment (UE) activates the access stratum (AS) by initiating a mobility management attach procedure.

9. The method according to claim 1, wherein the user equipment (UE) activates the access stratum (AS) by initiating a mobility management tracking update procedure.

10. A user equipment (UE), comprising:
a transceiver, configured to wirelessly communicate with a network; and
a processor, coupled to the transceiver and configured to perform operations comprising:
determining whether an access stratum (AS) is deactivated due to a discontinuous coverage or during the discontinuous coverage in a mobility management; and
entering a specific state, when the access stratum (AS) is deactivated due to the discontinuous coverage or during the discontinuous coverage in the mobility management;
wherein
the specific state is either an xMM-DEREGISTERED.NO-CELL-AVAILABLE state entered by the user equipment (UE), when either the access stratum (AS) is deactivated due to the discontinuous coverage or the user equipment (UE) is in the discontinuous coverage and the user equipment (UE) is in deregistered state; or
an xMM-REGISTERED.NO-CELL-AVAILABLE state entered by the user equipment (UE), when either the access stratum (AS) is deactivated due to the discontinuous coverage or the user equipment (UE) is in the discontinuous coverage and the user equipment (UE) is in the registered state.

11. The user equipment (UE) according to claim 10, wherein the mobility management is EPS mobility management (EMM), the xMM-DEREGISTERED.NO-CELL-AVAILABLE state is an EMM-DEREGISTERED.NO-CELL-AVAILABLE state, and the xMM-REGISTERED.NO-CELL-AVAILABLE state is an EMM-REGISTERED.NO-CELL-AVAILABLE state.

12. The user equipment (UE) according to claim 10, wherein the mobility management is 5G mobility management (5GMM), the xMM-DEREGISTERED.NO-CELL-AVAILABLE state is a 5GMM-DEREGISTERED.NO-CELL-AVAILABLE state, and the xMM-REGISTERED.NO-CELL-AVAILABLE state is a 5GMM-REGISTERED.NO-CELL-AVAILABLE state.

13. The user equipment (UE) according to claim 10, wherein the user equipment (UE) is further configured to perform operations comprising:
entering the specific state, when an unavailability period is activated due to discontinuous coverage.

14. The user equipment (UE) according to claim 10, wherein the user equipment (UE) is further configured to perform operations comprising:
entering the specific state, when the user equipment (UE) activates an unavailability period.

15. The user equipment (UE) according to claim 10, wherein the user equipment (UE) is further configured to perform operations comprising:
entering the specific state, when the access stratum (AS) is deactivated for a 3GPP access.

16. The user equipment (UE) according to claim 10, wherein the user equipment (UE) initiates a mobility management procedure for cell and PLMN reselection.

17. The user equipment (UE) according to claim 10, wherein the user equipment (UE) activates the access stratum (AS) by initiating a mobility management attach procedure.

18. The user equipment (UE) according to claim 10, wherein the user equipment (UE) activates the access stratum (AS) by initiating a mobility management tracking update procedure.
